(19) United States
(12) Patent Application Publication
(10) Pub. No.: US 2026/0060233 A1
(43) Pub. Date: Mar. 5, 2026

(54) Method and Apparatus for Humane Mole Eradication

(71) Applicant: Keith Luther, Salina, KS (US)

(72) Inventor: Keith Luther, Salina, KS (US)

(21) Appl. No.: 18/822,329

(22) Filed: Sep. 2, 2024

(51) Int. Cl. A01M 17/00

(52) U.S. Cl. CPC A01M 17/00

(57) ABSTRACT

An Apparatus for Mole Eradication incorporating a shaft having an upper end and a lower end; a “T” handle fixedly attached to the shaft's upper end; a “U” bracket having an upper web, and having a pair of downwardly extending arms, the lower end of the shaft being fixedly attached to the upper web; a step plate fixedly attached to lower ends of the “U” bracket's arms; and a multiplicity of lances fixedly attached to and extending downwardly from the step plate, wherein the lances present mole engaging ridges or barbs for humanely extracting the mole from the lawn.

### FIELD OF THE INVENTION

This invention relates to apparatus, methods, processes, and procedures which are adapted for eradication of moles from grass lawns. More particularly, this invention is directed to such apparatus and methods which mechanically lance or stab moles.

### BACKGROUND OF THE INVENTION

Moles are subterranean dwelling mammals which have the ability to recycle oxygen for survival beneath the ground. While moles do not have outer ears, moles have a sensitive sense of hearing which allows them to hear or sense the movements of insects, insect nymphs, and larva within the ground, and to sense vibrations within the ground. Moles are insectivores which commonly grow to between 4 inches and 7 inches in length.

Moles commonly tunnel and feed within a lawn during cool early morning hours or late evening hours. During active feeding, a mole may tunnel through a lawn's root system approximately 11 feet per hour. During a complete feeding day, a single mole may tunnel up to 200 feet. A mole or group of moles may tunnel and feed within a single grass lawn for a period of weeks, resulting in extreme damage to the lawn's root system.

Known apparatus, systems, and methods for lancing or stabbing moles within a lawn are commonly mechanically complex and are commonly unreliable. Such apparatus' also tend to injure a mole without killing it, leaving an injured mole to suffer an inhumane lingering death. The instant inventive apparatus and method for mole eradication solves or ameliorates such deficiencies by providing a mechanically simple apparatus, and by providing easily followed and easily performed method steps which reliably and humanely eradicate moles from a grass lawn.

### BRIEF SUMMARY OF THE INVENTION

The apparatus which is provided in the instant inventive apparatus and method for humane mole eradication comprises a shaft having an upper end and a lower end. In a suitable embodiment, the shaft component may comprise a length of steel tubing or piping having a diameter between ¾^{th} inches and 1¼^{th} inches, and having a length between 3 and 4 feet. In a suitable alternative embodiment, the shaft component may be composed of wood. A further structural component of the instant inventive apparatus comprises a T-handle, which is fixedly attached to the shaft's upper end. In a preferred embodiment, the T-handle comprises a second length of steel tubing or piping having a diameter between ¾ inches and 1¼ inches. In the preferred embodiment, the T-handle is attached to the shaft's upper end to form left and right hand grip extensions. Plastic or synthetic rubber hand grip sleeves are preferably installed over such T-handle ends.

A further structural component of the instant inventive apparatus comprises a U-bracket having left and right downwardly extending arms and having an upper web which spans between upper ends of such arms. In the preferred embodiment, the lower end of the shaft is fixedly attached to the U-bracket's web so that the shaft and T-handle extend upwardly therefrom.

A further structural component of the instant inventive apparatus comprises a step plate which extends substantially horizontally, and which is fixedly attached to the lower or distal ends of the U-bracket's left and right arms. In a preferred embodiment, the step plate component is circular, and has a diameter between 5 inches and 7 inches. The step plate component in combination with the U-bracket's web, left arm, and right arm, advantageously forms and defines an open foot insertion space.

A further structural component of the instant inventive apparatus comprises a plurality of lances which is fixedly attached to and which extends downwardly from a lower surface of the step plate. In the preferred embodiment, the lances are circularly arrayed within a cylindrical volume which matches the preferred circular shape of the step plate. In a preferred embodiment, the lances have pointed lower ends, which are displaced by the lance's shafts between 3 inches and 5 inches below the step plate's lower surface.

The instant inventive apparatus preferably further incorporates and provides a foot friction enhancing step pad which is fixedly attached to the upper surface of the step plate. Multiplicities of mole engaging ridges which extend about and extend horizontally from the lances are also preferably provided. Mole snaring barbes mounted at the lower ends of the lances may be alternatively provided.

In use of the inventive apparatus in accordance with preferred steps of the inventive mole eradication method, a homeowner operator may secure ready access to the apparatus. The homeowner may view his or her grass lawn during a period of common mole active feeding, typically during early morning hours. During feeding, a mole's active tunneling will induce a visually perceivable and detectable upwelling of the grass. Upon seeing such mole tunneling induced upwelling of the grass, the homeowner may, while carrying the apparatus, walk onto the lawn toward the upwelled section of the grass. During such walking, the mole typically detects vibrations in the lawn, and ceases moving.

Upon reaching the upwelled area, the homeowner may align the step plate and lances of the apparatus directly over the upwelled area. Thereafter, the operator may use his or her left and right hands to grasp the left and right T-handle extensions to initially drive the lances downwardly into the ground. Thereafter, the homeowner may move one of his or her legs forwardly toward the apparatus to cause his or her foot to enter the apparatus's foot insertion space. Thereafter, the homeowner may forcefully step downwardly upon the step plate, further driving the lances downwardly into the ground.

The preferred circular array configuration of the lances combined with such array's preferred 5 inches to 7 inches diameter assures that some of the lances within the array will coincide with the location of the mole. Such downward lance thrusting and driving steps advantageously impinges against and pierce the tunneling mole.

Friction ridges provided on the lances, or alternatively, mole snaring barbs, assure secure frictional contact between the lances and the pierced mole. Accordingly, upon upward extraction of the lances from the lawn, the mole is upwardly extracted from the lawn. In the event that the downward thrust of the lances has not killed the mole, the extracted mole may be quickly and humanely euthanized.

Accordingly, objects of the invention include the provision of a mole eradication apparatus which incorporates structures as described above, and which arranges those structures in relation to each other in the manners described above for the performance of beneficial functions described above. Further objects of the instant invention include the provision of mole eradicating steps as described above. Other and further objects, benefits, and advantages of the instant invention will become known to those skilled in the art upon review of the detailed description which follows, and upon review of the appended drawings.

### BRIEF DESCRIPTION OF DRAWINGS

FIG. 1 is a front view of an apparatus which is preferably provided in the instant inventive apparatus and method for humane mole eradication.

FIG. 2 is a magnified view of a lower end portion of the structure of FIG. 1.

FIG. 3 is a partial magnified view as indicated in FIG. 2.

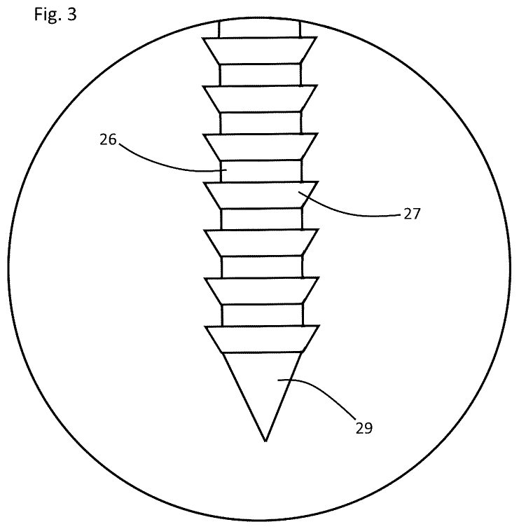

FIG. 4 is an alternative configuration of the structure of FIG. 3.

FIG. 5 is a bottom view of the structure of FIG. 1.

FIG. 6 is a partial perspective view of the structure of FIG. 1.

FIG. 7 depicts a mole tunneling within a lawn.

FIG. 8 depicts an initial apparatus usage step.

FIG. 9 depicts a subsequent apparatus usage step.

### DETAILED DESCRIPTION OF THE INVENTION

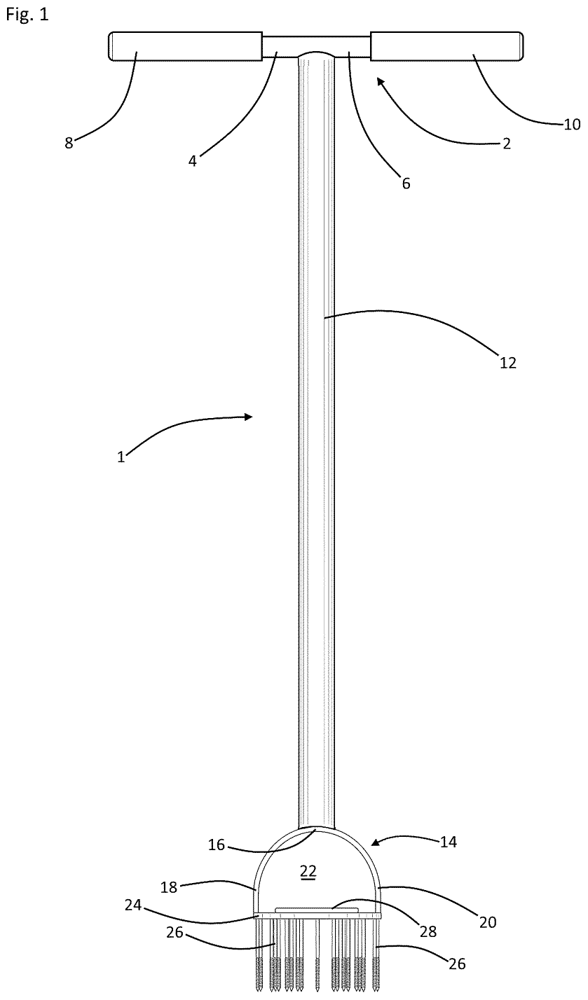

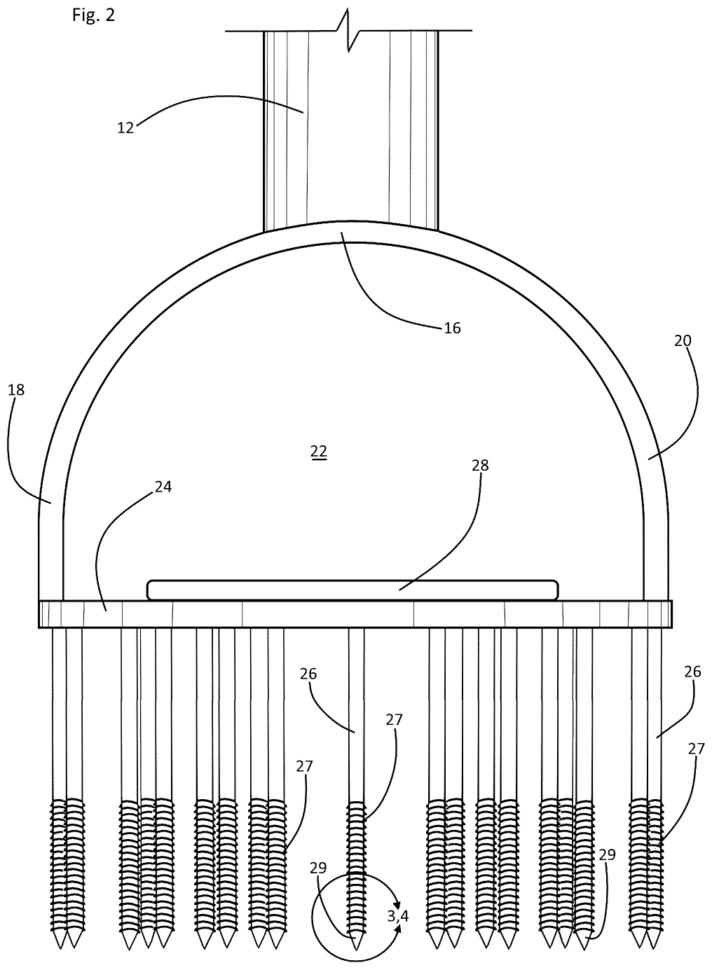

Referring now to the drawings, and in particular simultaneously to FIGS. 1 and 2, a preferred embodiment of an apparatus provided in accordance with the instant inventive apparatus and method for humane mole eradication is referred to generally by reference arrow 1. The apparatus 1 preferably comprises a vertical shaft 12 which may suitably be composed of steel tubing or piping. In a preferred embodiment, the shaft 12 is between 3 feet and 4 feet in length.

A T-handle 2 is preferably fixedly attached by welding to the upper end of the shaft 12, the T-handle 2 forming right and left handle extensions 4 and 6. In a preferred embodiment, the T-handle 2 is composed of a second length of steel tubing welded perpendicularly to the shaft's upper end. Grip enhancing sleeve configured hand grips 8 and 10 are preferably slidably mounted over the T-handle's right and left handle extensions 4 and 6.

A “U” bracket which is referred to generally by reference arrow 14 is preferably fixedly welded to the lower end of the shaft 12. In a preferred embodiment, the “U” bracket 14 comprises right and left arms 18 and 20, and comprises an upper web 16 which spans between and interconnects upper ends of such arms. In a suitable embodiment, the right and left arms 18 and 20 may alternatively extend substantially perpendicularly from the plate 24, such extension being approximately 2 inches to 3 inches.

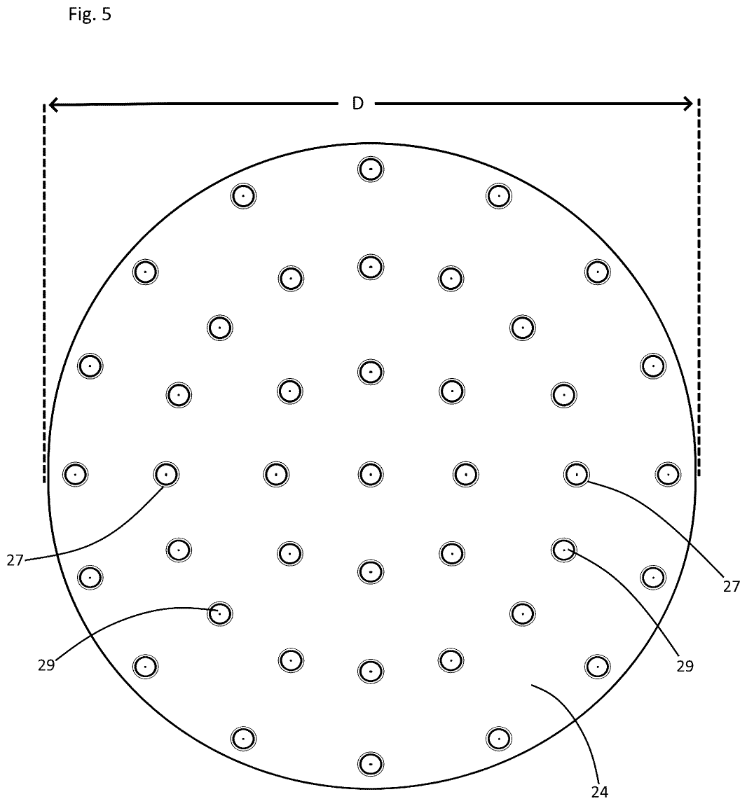

A step plate 24 is preferably fixedly welded to the lower or distal ends of the “U” bracket's right and left arms 18 and 20. In a preferred embodiment, the step plate 24 is composed of durable steel and the lower ends of arms 18 and 20 are preferably positioned at the step plate's outer periphery. Referring further to FIG. 5, the step plate 24 has a diameter “D”, preferably between 5 and 7 inches. A stepping friction enhancing pad 28 is preferably adhesively attached to the upper surface of the step plate 24. The step plate 24 in combination with the “U” bracket's right and left arms 18 and 20, and web 16 advantageously forms and defines a foot insertion space 22.

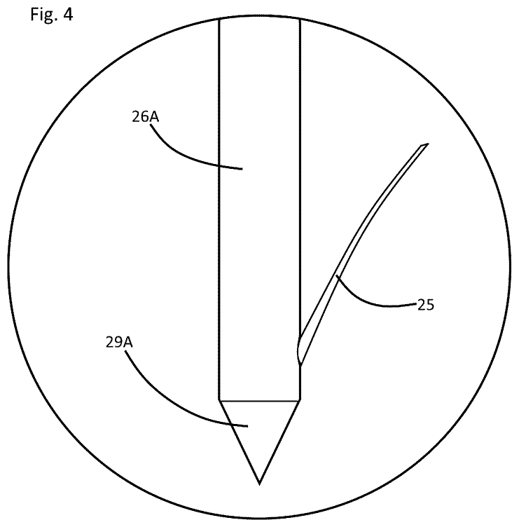

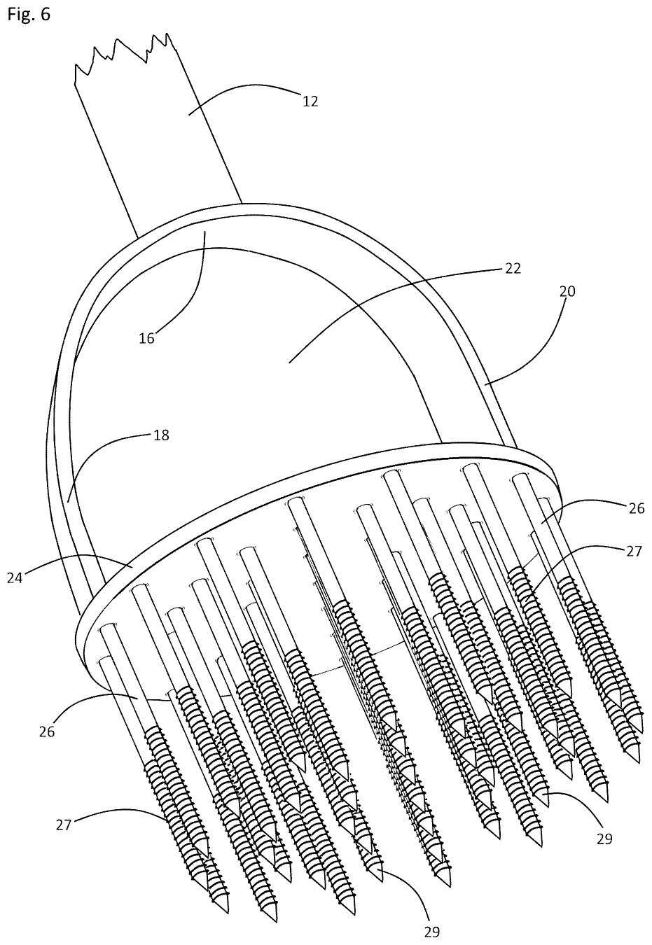

A plurality of lances 26 are preferably provided. Each of the lances 26 preferably comprises a downwardly extending steel shaft having a lower point 29. The upper ends of the lances 26 may be directly welded to plate 24. Alternatively, the plate 24 may comprise upper and lower stratums, and the lances may comprise enlarged heads sandwiched between said stratums. Each such lance also further presents a multiplicity of friction enhancing and mole engaging ridges 27 which extend horizontally and radially outwardly from the lances 26. Referring further to FIG. 4, mole snaring barbs 25 may be mounted at the points 29A of alternatively configured lance shafts 26A. As shown in FIGS. 5 and 6, the lances 26 preferably form a circular cylindrical array which matches the preferred circular shape of the step plate 24.

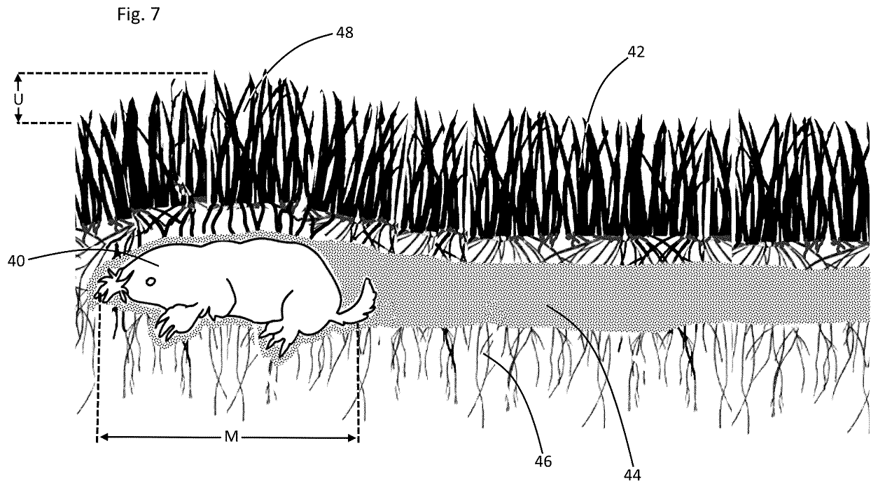

Referring to FIG. 7, in use of the apparatus 1 during performance of the inventive mole eradication method, a homeowner may carefully view his or her grass lawn 42 during an early morning hour when moles, such as mole 40, commonly actively tunnel along the surface of the lawn to feed upon insects. As the mole 40 digs to create a tunnel 44 through the lawn's root system 46, the mole's body commonly provides a visually detectable upwelling 48 within the lawn 42. Where the mole 40 has a common body length “M” between 4 and 7 inches, such lawn upwelling 48 may have a height “U” between 1 inch and 2 inches above the surrounding grass areas. By carefully watching the lawn, the homeowner can see such upwelling 48 progressively moving along the lawn's surface.

Upon seeing the mole produced upwelling 48 within the lawn 42, the homeowner may walk onto the lawn 42 toward the upwelling 48 while wielding the apparatus 1. Moles are commonly sensitive to ground vibrations induced by persons walking upon the lawn. In response to such vibrations, the mole 40 commonly ceases digging and remains sessile or temporarily fixed at the perceived upwelling 48. Accordingly, the homeowner's initially performed step of entering the lawn and walking toward a perceived upwelling advantageously operates to fix the mole at the location of the upwelling.

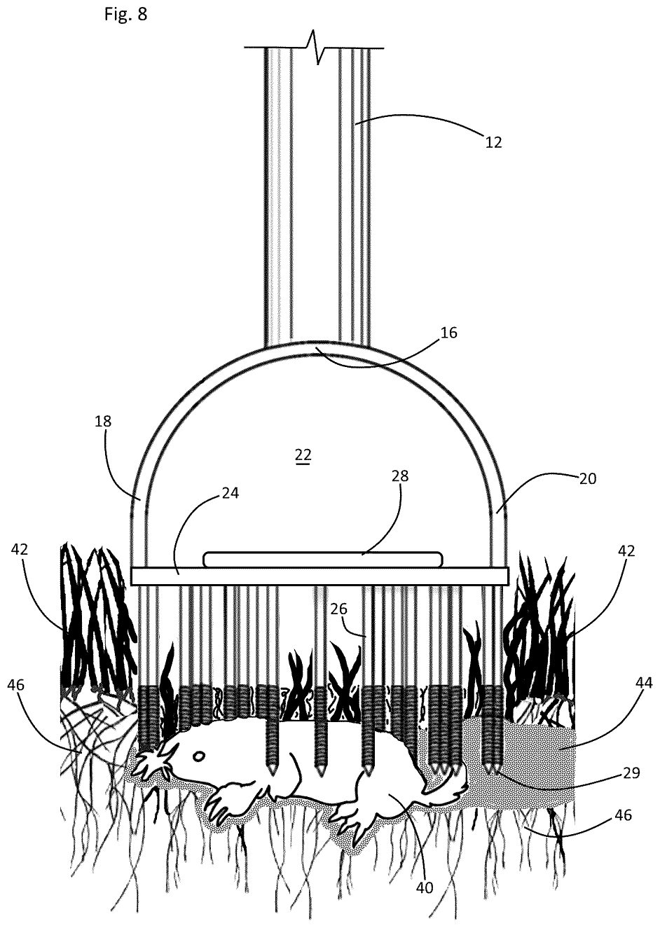

Upon reaching the upwelling 48, the homeowner may align the plate 24 and lances 26 directly over the upwelling 48. Thereafter, the operator may grasp handgrips 8 and 10 in his or her right and left hands, and may forcefully drive the lances 26 downwardly into the ground. Referring to FIG. 8, such hand induced downward driving of the apparatus' lances may partially pierce the lawn 42 and the mole 40.

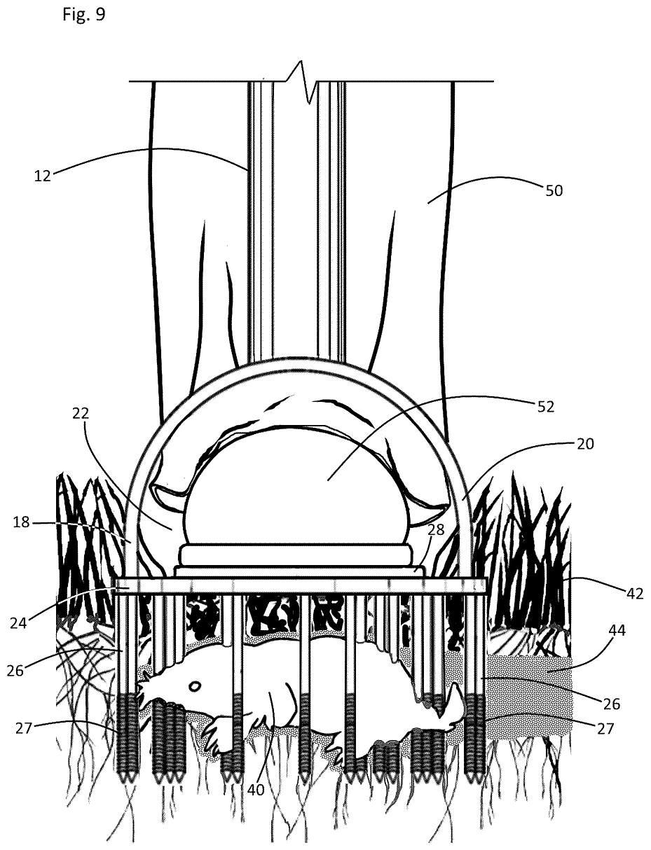

Thereafter, referring further to FIG. 9, the homeowner may move one of his or her legs 50 and the toe 52 of his or her foot toward the apparatus 1 so that such toe 52 enters the apparatus' foot insertion space 22. Thereafter, the homeowner may forcefully step downwardly upon friction pad 28 and upon plate 24 to further drive the lances 26 downwardly into and through the mole 40. Ridges 27 which extend about and extend horizontally from the lances 26 advantageously frictionally engage the mole so that, upon upward extraction of the apparatus from the lawn 42, the mole is simultaneously upwardly withdrawn from the lawn. Alternatively provided barbs 25, as shown in FIG. 4, may alternatively frictionally snare the mole 40, assuring that the upward extraction of the lances 26 from the lawn 42 also upwardly extracts the mole.

Upon initially thrusting and driving the lances 26 into the ground at the location of upwelling 48, the homeowner may not have any accurate knowledge of the effect of the lances 26 upon the mole. In one possible circumstance, the lances 26 may completely miss the mole 40. In another possible circumstance, the mole 40 may be merely injured by the lances 26. In absence of the invention's provided frictional mole engaging members, such as ridges 27 or barbs 25, the homeowner's upward extraction of the lances 26 may undesirably leave the mole 40 in the ground, and upon such extraction, the homeowner would lack knowledge of whether the mole has been missed, injured, or killed. Accordingly, without the invention's mole engaging ridges 27 or barbs 25, a pierced and merely injured mole may be inhumanely left in the ground to die from the injuries at a later time.

The instant invention's mole engaging ridges 27 or barbs 25 advantageously provide for a performance of a humane mode of eradication of moles by assuring the extraction of a mole that is merely injured by a piercing lance. Pierced and merely injured moles which are extracted from the ground by the inventive apparatus through the operation of the ridges 27 or the barbs 25 may be quickly and humanely euthanized by the homeowner. Accordingly, the instant inventive method and apparatus operate to both eradicate moles and avoid an infliction of an inhumane and lingering underground death of a mole which is injured and is not immediately killed.

While the principles of the invention have been made clear in the above illustrative embodiment, those skilled in the art may make modifications to the structure, arrangement, portions, components, and method steps of the invention without departing from those principles. Accordingly, it is intended that the description and drawings be interpreted as illustrative and not in the limiting sense, and that the invention be given a scope commensurate with the appended claims.

1-3. (canceled)

4. An apparatus for mole eradication comprising:
a. a shaft having an upper end and a lower end;
b. a “T” handle fixedly attached to the shaft's upper end;
c. a “U” bracket having an upper web, and having a pair of downwardly extending arms, the lower end of the shaft being fixedly attached to the upper web;
d. a circular plate fixedly attached to the “U” bracket;
e. a circular cylindrical volume underlying the circular plate;
f. a plurality of lances fixedly attached to and extending downwardly from the circular plate, each lance being adapted for frictional mole engagement; and
g. a foot insertion space upwardly bounded by the “U” bracket's web, the foot insertion space being downwardly bounded by the circular plate, wherein the lances are circularly arrayed within the circular cylindrical volume.

5. The apparatus for mole eradication of claim 4, wherein each lance has a point positioned between 4 inches and 6 inches below the circular plate.

6. The apparatus for mole eradication of claim 5, wherein the “U” bracket's arms have distal ends, and further comprising a step pad fixedly attached to the circular plate, the step pad being positioned between said distal ends.

7. The apparatus for mole eradication of claim 6, wherein the step pad is composed of a high friction elastomeric material.

8. The apparatus for mole eradication of claim 7, wherein the “T” handle has a pair of distal ends, and further comprising a pair of hand grips, each hand grip being fixedly attached to one of the “T” handle's distal ends.

9. The apparatus for mole eradication of claim 4, wherein the adaptation for frictional mole engagement comprises multiplicities of friction ridges, each multiplicity of friction ridges extending horizontally from one of the lances.

10. The apparatus for mole eradication of claim 4, wherein the adaptation for frictional mole engagement comprises a plurality of barbs, each barb being fixedly attached at a lower end of one of the lances.

11. A method for eradicating moles from a grass lawn comprising steps of:
a. Providing an apparatus which incorporates a shaft having an upper end and a lower end; a “T” handle fixedly attached to the shaft's upper end; a “U” bracket having an upper web, and having a pair of downwardly extending arms, the lower end of the shaft being fixedly attached to the upper web; a circular step plate fixedly attached to the “U” bracket; a circular cylindrical volume underlying the circular step plate; a plurality of mole friction enhanced lances fixedly attached to and extending downwardly from the plate, said lances being circularly arrayed within the circular cylindrical volume; and a foot insertion space upwardly bounded by the “U” bracket's web, the foot insertion space being downwardly bounded by the circular step plate;
b. Viewing the grass lawn to visually detect a mole presence indicating upwelling;
c. Aligning the multiplicity of lances over the upwelling;
d. Driving the apparatus downwardly until the plurality of lances within the circular cylindrical volume pierces the lawn;
e. Inserting a foot into the foot insertion space;
f. Stepping downwardly upon the circular step plate to further pierce the lawn, and to pierce the mole; and
g. Upwardly withdrawing the lances and the pierced mole from the lawn.

12. The method of claim 11, wherein the enhancement for mole friction of the lance comprises barbs or ridges extending from the lances, wherein the barbs or ridges engage the mole, and wherein the step of upwardly drawing the lances from the lawn humanely upwardly extracts the barb or ridge engaged mole from the lawn.
